(19) United States
(12) Patent Application Publication
(10) Pub. No.: US 2007/0287065 A1
(43) Pub. Date: Dec. 13, 2007

(54) Electrochemical electrode surface encapsulation

(76) Inventors: Ling-Feng Li, Croton-on-Hudson, NY (US); Zeiad Muntasser, San Diego, CA (US); Boris Kukovitskiy, Brooklyn, NY (US)

Correspondence Address: REVEO, INC., 3 WESTCHESTER PLAZA, ELMSFORD, NY, 10523, US

(21) Appl. No.: 11/451,629

(22) Filed: Jun. 12, 2006

(51) Int. Cl. H01M 4/40; H01M 4/46; B05D 5/12; H01M 2/16

(52) U.S. Cl. 429/218.1; 429/246; 429/231.95; 429/231.6; 427/123

(57) ABSTRACT

The present invention is directed to a metal air electrochemical cell whereby the anode is encapsulated with a protective layer. The encapsulated metal air anode provides prolonged submersion of anodes in electrolyte, improved metal anode discharge and decreased metal anode corrosion.

### BACKGROUND

Anodes, which can be stored for long periods of time that possess significant, discharging capacity, are essential for remote use. However, as with many anodes, which yield significant discharging capacities, they are highly reactive. Currently there is little that can be done to increase the shelf life of these highly reactive anodes. An example of such a highly reactive anode is aluminum.

Since Zaromb first demonstrated the aluminum air system in the 1960s, the high theoretical specific energy of the aluminum air system has been distinguished and praised for its superiority to other systems. With a theoretical specific energy yield of 8100 Wh/kg, due to aluminum's high theoretical cell voltage and high specific capacity, the benefits of aluminum air cells are well recognized.

Because aluminum air cells can be refueled rapidly by just replacing the aluminum anode and electrolyte, aluminum air systems are more like fuel cells, rather than primary batteries. It is this unique refueling feature, which makes the aluminum air system more attractive in terms of specific energy. In addition, the aluminum air cells do not present a significant hazard to the environment like other metals used for anode material.

However, despite the advantages of the aluminum air cell and its high-theoretical specific energy, in reality there are limitations. At present, extensive work has been done to interpret aluminum corrosion mechanism in alkaline solution. However, despite extensive research in inhibition mechanisms of aluminum air cells in alkaline solution, corrosion of aluminum air cells still occur. It is generally recognized that the corrosion rate of aluminum depends strongly on solution,temperature, on the impurity of the aluminum, especially its Fe content and most notable electric double layering. As with all electrodes once immersed in an electrolyte the electronic charge on the anode attracts ions of the opposite charge from the electrolyte. This ionic attraction creates a layer of charge on the anode and a layer of charge on the electrolyte interface. Thus, creating an adjoining orientation of layers commonly known as electrical double layering.

Double layering causes many difficulties for aluminum air cell anodes. Foremost, when pure aluminum is submerged in caustic electrolyte solution, water and other ionic species such as OH— will form an electric double layer on the anode interface. The double layer causes instability in the aluminum, because water will react with aluminum upon contact and initiate the production of an oxide or hydroxide layers, which then generate hydrogen. However, do to the oxide's strong solubility in alkaline solution the passive layer will not build up considerably. Nevertheless, the bubbling of the hydrogen will prompt self-agitation, which accelerates self-corrosion of the aluminum.

For the forgoing reasons, there exists a need for a composition and method that can protect the anode by minimizing or eliminating anode corrosion.

### SUMMARY

The present invention is directed to a metal air electrochemical cell (e.g. Al, Mg, Li, Na) whereby the anode is encapsulated or includes a self-assembling chemical system attached to the encapsulated layer. Such encapsulated metal air anodes provides prolonged submersion of anodes in electrolyte, improved metal anode discharge and decreased metal anode corrosion.

### BRIEF DESCRIPTION OF THE FIGURES

FIG. 1 is a general schematic of an anode system showing an encapsulating metallic layer;

FIG. 2 is a general schematic of an anode system showing an encapsulating metallic layer and a self-assembling layer.

### DETAILED DESCRIPTION

The present invention relates to a composition and method for an encapsulating layer, further a self-assembling chemical may be affixed to a metal anode, wherein the encapsulating layer with or without the self-assembling chemical protects the anode once it has been submerged in the electrolyte, thereby minimizing or eliminating anode corrosion. Metal air electrochemical cells are known, and generally include a metal fuel anode, an electrolyte and an air cathode in electrical isolation from the anode. Metals particularly suitable to the invention herein include Al, Mg, Li, Na, and other high activity oxidizable metals.

Further, these metals may also be alloyed with constituents including, but not limited to, bismuth, indium, lead, mercury, gallium, tin, cadmium, molybdenum, tungsten, chromium, vanadium, germanium, arsenic, antimony, selenium, tellurium, strontium, calcium, lithium, magnesium, ferrous metals. During conversion in the electrochemical process, the metal is generally converted to a metal oxide.

In metal air electrochemical cells, an air cathode is maintained in electrical isolation from the anode, ionic communication is maintained through a separator. The air cathode may be a conventional air diffusion cathode, for example generally including an active constituent and a carbon substrate, along with suitable connecting structures, such as a current collector. The carbon used is preferably chemically inert to the electrochemical cell environment and may be provided in various forms including, but not limited to, carbon flake, graphite, other high surface area carbon materials, or combinations comprising at least one of the foregoing carbon forms. A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E. I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent of an air cathode is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials. An exemplary air cathode is disclosed in U.S. Pat. No. 6,368,751, entitled “Electrochemical Electrode For Fuel Cell”, to Wayne Yao and Tsepin Tsai, granted on Apr. 9, 2002, which is incorporated herein by reference in its entirety. Other air cathodes may instead be used, however, depending on the performance capabilities thereof, as will be apparent to those of skill in the art.

In a metal air electrochemical cell, oxygen from the air or another source is used as the reactant for the air cathode of the electrochemical cell. When oxygen reaches the reaction sites within the cathode structure, it is converted into hydroxyl ions together with water. At the same time, electrons are released to flow as electricity in the external circuit. The hydroxyl ions travel through the electrolyte to reach the metal fuel material of the anode. When hydroxyl reaches the metal anode (in the case of an anode comprising, for example, aluminum), aluminum hydroxide is formed on the surface of the aluminum. Aluminum hydroxide decomposes to aluminum oxide and releases water back to the alkaline solution. The reaction is thus completed.

The anode reaction is:

Al→Al⁺³+3e⁻ (1)

The cathode reaction is:

O₂+2H₂O+4e→4OH⁻ (2)

Thus, the overall cell reaction is:

4Al+3O₂+6H₂O→4Al(OH)₃ (3)

The electrolyte used in the electrochemical cell generally comprises ion-conducting material to allow ionic conduction between the metal anode and the cathode. The electrolyte generally comprises hydroxide-conducting materials such as KOH, NaOH, LiOH, RbOH, CsOH or a combination comprising at least one of the foregoing electrolyte media. In preferred embodiments, the hydroxide-conducting material comprises KOH. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 48% ionic conducting materials.

It is a well known problem that the corrosive effect on highly reactive anode once placed in electrolyte solution severely hinders the performance of the electrochemical cell. Furthermore, it limits the ability of the anode to remain submerged in the electrolyte solution for long periods of time when it is not active. Finally, the gassing of hydrogen conventionally leads to problems such as self discharge and also prevents application of the cell in environments where the hydrogen gassing could be dangerous.

Therefore, to overcome the corrosive effect, an encapsulating composition and method are provided, which coats the anodes of an electrochemical cell thereby producing an encapsulating metal layer. It is through encapsulation that the stability and integrity of a highly reactive anode can be maintained. Additionally, self-assembling molecules can be affixed to the encapsulating layer to further prevent anode corrosion. With the addition of these self-assembling molecules the encapsulation layer is modified by automatic molecular alignment. The encapsulating layer with the self-assembling molecules or without the self-assembling molecules prolongs the life of the anode once submersed in electrolyte and enhances the discharging ability of the electrochemical cell. Moreover, encapsulation of the anode with or without the self-assembling molecules reduces hydrogen evolution thereby preventing self-agitation, which can lead to self-corrosion of the highly reactive anode.

Through encapsulation the anode is protected from corrosion, which is caused when the anode is placed in caustic electrolyte solution. When the anode is encapsulated a coat of metal or a combination of metals are situated around the anode, thereby isolating the anode from the caustic electrolyte solution until discharge, e.g., application of a load to the electrochemical cell. Generally, the encapsulation layer is more corrosion resistant toward the caustic electrolyte, yet sufficiently capable of being destroyed during the initial discharge thereby exposing the desired metal anode for electrochemical reaction.

Various metals and alloys may be used for encapsulation. Suitable metals include, but are not limited to Zn, Sn, Cd, Bi, Pb, In and/or combinations and alloys of at least one of the forgoing metals. Further, metal/alloy powder blends incorporating binder material may be used for encapsulation. In preferred embodiments, the encapsulation layer is more corrosion resistant to the alkaline electrolyte than the underlying anode material, but can still be destroyed by the initial discharging in order to expose the underlying anode material, e.g., aluminum. Further, the thickness of the encapsulation layer may vary from sub-micron to hundred of microns. In one embodiment the encapsulation layer includes Zn or its alloy as a surface metal. Because, of zinc's properties as a metal anode (i.e. is a common metal anode in metal air cells) and its ability to be discharged in alkaline electrolyte, there is no initial performance delay once discharging begins.

To further reduce anode corrosion and to facilitate anode encapsulation, the surface of the anode is morphological alternated. When an anode as a rough surface, there are more points of contact in which electrolyte can cause corrosion. However, through roll pressing and polishing the rough surface of the anode can be smoothed.

Through roll pressing the anode may be polished with an abrasive surface and then pressed with hard surfaces (e.g., roller(s)). The space between the hard surfaces and anode is then decreased until the surface of the anode becomes shiny. The anode is then cleaned with a solvent to remove any possible contaminations.

In one embodiment the anode is polished with sandpaper and then pressed between a rolling machine. While in the rolling machine the gap between the rollers is reduced gradually to the desirable final thickness. Thereby producing a final anode with a shiny surface.

In another embodiment mechanical polishing is used to smooth the surface of the anode. Unlike roll pressing the process of mechanical polishing avoids contamination by steel rollers. For example, anode may be abraded with sandpaper, then the surface polished with polishing paste.

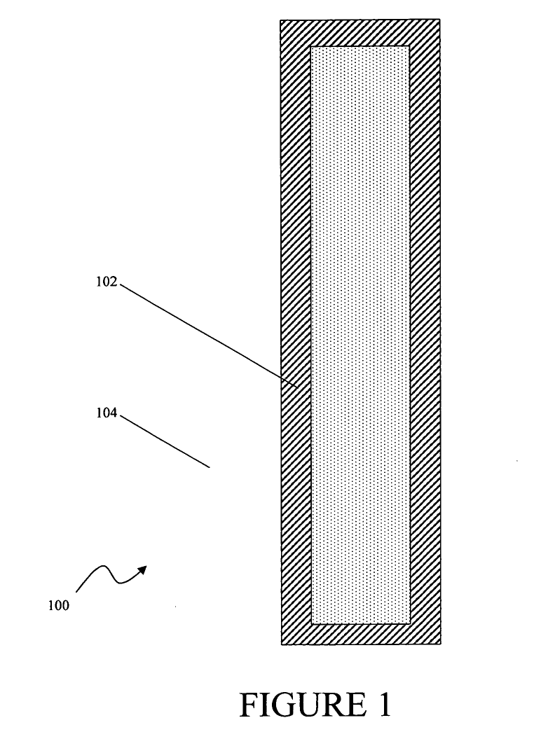

Referring to FIG. 1, an anode 100 is depicted. The anode includes metal fuel 102 encapsulated within a metallic layer 104. The encapsulation layer maybe applied to the anode by several methods.

In one embodiment the application of the surface metal as a protective layer in the encapsulation process is accomplished by physical vapor deposition. In yet another embodiment the encapsulation layer is formed by electrochemical deposition. In a further embodiment, the encapsulation layer is formed by electroless plating.

The process according to the present invention for encapsulating the aluminum anode by an electrochemical deposition includes the steps of exposing the anode to a caustic solution for a sufficient period of time. Optionally, the anode may be rinsed with water. Then the anode is exposed to a metal oxide solution for a sufficient period of time in order to facilitate encapsulation.

In one embodiment the anode is exposed to a caustic solution (i.e. NaOH). Then the anode may be rinsed in de-ionized water. The anode can then be exposed to various concentrations of NaOH and ZnO solution for a sufficient period of time. In a preferred embodiment NaOH has a concentration of 10% and ZnO 4%. Since aluminum or lithium are more active than the zinc, once the anode is exposed to the NaOH and ZnO solution the zinc will be reduced and deposit onto the aluminum surface. Consequently, the zinc will coat the anode, thereby encapsulating the anode and effectively isolating the anode from the caustic electrolyte once the anode has been submerged.

In another embodiment the encapsulation of the anode is achieved by physical vapor deposition. Under this process the surface layer formed by physical vapor deposition is usually smooth and uniform. Further, the thickness of the encapsulation layer can be varied. Depending on the length of storage time needed while the anode is inactive and submerged in the caustic electrolyte, the thickness of the encapsulation layer can be manipulated during the encapsulation process. This can be accomplished by increasing or decreasing the time of deposition. Consideration should be taken to balance the desired storage time against the desired

Still another embodiment for anode encapsulation is cold galvanization. Cold galvanization is generally mechanical covering of an anode with a composition, which consists of encapsulating metal powder or dust, binder and solvent. Applied on the anode surface this composition gives a solid film after the solvent evaporates.

The metal powder or dust in the film may be integrated with organic binders. These binders allow the metal particles to remain in contact with each other, providing the anode protection. Various stables alkaline electrolyte binders can be used for cold galvanizing. Suitable binders include, but are not limited to resins, polyvinyl alcohol, poly (vinyl butyrol-co-vinyl alcohol-co-vinyl acetate). The solvents should dissolve appropriate binder well and preferably should be volatile. Suitable solvents include, but are not limited to mineral spirits, iso-propanol, and acetone. In a preferred embodiment metal particles have a concentration of 50%-95%, solvent have a concentration of 5%-50% and binder have a concentration 0.1%-10%. In a preferred composition of the solid film after the evaporation of the solvent has a concentration of metal particles 85%-99%.

In still another example, electroless deposition may be employed. Electroless deposition is an easy and controllable way to deposit metals such as Zn, In, Sn, Bi, Pb, Cd on the aluminum or aluminum alloys surface. Different surface layers or different surface layer thickness could affect the alloy discharging performance as well as the anticorrosion properties. The deposit layer thickness is generally a function of time of electroless deposition.

In a further embodiment, a combination of materials may be deposited. For example, a layer of zinc may be formed on the aluminum or aluminum alloy, and a layer of tin on the zinc. As is known, electrochemical activity of the metal is as following: Al>Zn>In, Sn. Therefore, the upper layer of inactive tin should be rather thin to avoid performance reducing. The next layer, zinc, which also prevents corrosion, will not detrimentally affect the performance of the alloy (e.g., for up to 45 sec of deposition time, preferably up to about 20 sec deposition time). This combination is suitable to provide maximum anti-corrosion protection for the aluminum or aluminum alloy while maintaining its discharging performance.

In addition to the encapsulating layer coating the anode, self-assembling chemicals may be affixed to the encapsulating layer. Such self assembling layers may comprise of any suitable surfactant, such as anionic, cationic or non-ionic surfactants. Examples of anionic surfactants include dodecylbenzenesulfonic acid sodium salt and sodium lauryl sulphate. Examples of cationic surfactants include cetyl trimethyl ammonium bromide or chloride. Examples of non-ionic surfactants include triton X 100, polyethylene glycol and zonyl.

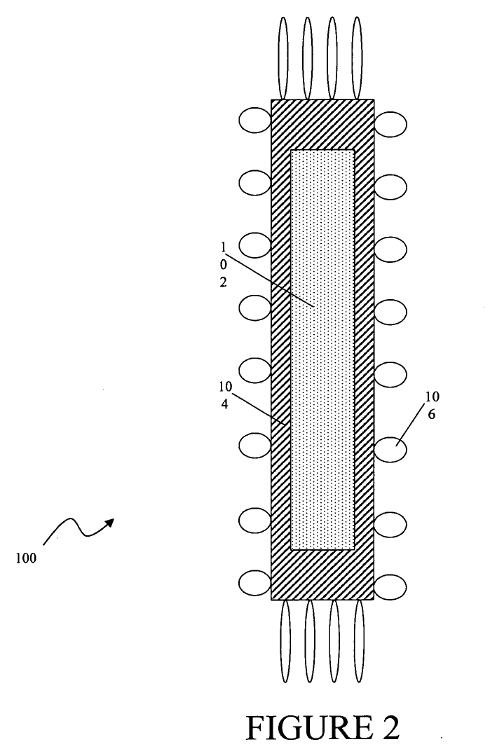

Referring to FIG. 2, an anode 100 is depicted. The anode includes metal fuel 102 encapsulated within a metallic layer 104 and a self-assembling layer 106. The addition of the self-assembling chemicals to the encapsulating layer of a coated anode can effectively modify the double layer structure of the metal electrode and thereby reduce the self-corrosion of the metal electrode in the caustic electrolyte.

Benefits of the present invention include long storage within the electrolyte (e.g., alkaline solution) without significant unwanted self-discharge or corrosion, for example, due to hydrogen gassing. This is particularly beneficial for highly active metal electrode such as aluminum, lithium and magnesium. The self-assembling layer further enhances the prevention or minimization of unwanted self-discharge or corrosion.

While preferred embodiments have been shown and described, various modifications and substitutions may be made thereto without departing from the spirit and scope of the invention. Accordingly, it is to be understood that the present invention has been described by way of illustrations and not limitation.

1-3. (canceled)

4. A method for encapsulating an active metal electrode, wherein said electrode is exposed to an encapsulating metal.

5. The method for encapsulating an active metal electrode as in claim 4 wherein said encapsulation layer is selected from the group consisting of Zn, Sn, Cd, Bi, Pb and In, and combinations comprising at least one of Zn, Sn, Cd, Bi, Pb or In.

6. The method for encapsulating an active metal electrode as in claim 4, wherein said method is performed by electrochemical deposition.

7. The method for encapsulating an active metal electrode as in claim 6, wherein said electrode is exposed to a caustic solution including a metal oxide solution for a sufficient period of time to encapsulate the anode.

8. (canceled)

9. The method for encapsulating an active metal electrode as in claim 7 wherein sa caustic solution has a concentration of 2% to 6% NaOH.

10. (canceled)

11. The method for encapsulating an active metal electrode as in claim 7, wherein said metal oxide solution has a concentration of 20% to 30% NaOR and 2% to 10% ZnO.

12. The method as in claim 12, wherein a thickness of encapsulation is controlled by time of exposure.

13. A method for encapsulating an active metal electrode as in claim 4, wherein said method is performed by cold galvanization.

14. The method for encapsulating an active metal electrode as in claim 4, wherein the encapsulating layer comprise of metal powder or dust.

15. The method for encapsulating an active metal electrode as in claim 14, wherein the metal powder or dust is integrated rough organic binders.

16. The method for encapsulating an active metal electrode as in claim 14, wherein the metal powder or dust is integrated with a solvent.

17-19. (canceled)

20. The method for encapsulating an active metal electrode as in claim 16, wherein said solvent is selected from the group consisting of volatile organic liquids, water, iso-propanol, acetone, mineral spirits, and aliphatic hydrocarbon.

21. The method for encapsulating an active metal electrode as in claim 15, wherein
said binder is selected from the group consisting of resins, polyvinyl alcohol, and poly (vinyl butyrol-co-vinyl alcohol-co-vinyl acetate).

22. The electrochemical cell as in claim 16, further wherein the metal powder or dust integrated with the solvent is further integrated with a binder is soluble in the solvent.

23. The electrochemical cell as in claim 1, further comprising a self-assembling chemical is attached to the encapsulated layer.

24. The electrochemical cell as in claim 23, wherein said self-assembling structure is a base compound.

25. The electrochemical cell as in claim 24, wherein said base compound has a pH of 8-14.

26. (canceled)

27. The electrochemical cell as in claim 24, wherein said hard base compound has a pH of 12-14.

28. The electrochemical cell as in claim 24, wherein said self-assembling hard base compound is selected from the group of compounds consisting of N, O and F.

29. The electrochemical cell as in claim 23, wherein said self-assembling structure is selected from the group consisting of long aliphatic chains, aromatic rings, polyamines, and zonyl series fluro-surfactants.

30-35. (canceled)
